(19) United States
(12) Patent Application Publication
(10) Pub. No.: US 2005/0133529 A1
(43) Pub. Date: Jun. 23, 2005

(54) Liquid feed system

(75) Inventors: Dennis Redman, Palmdale, CA (US); Emmanuel A. Hanna, Lakeview Terrace, CA (US)

Correspondence Address: CHRISTIE, PARKER & HALE, LLP, PO BOX 7068, PASADENA, CA, 91109-7068, US

(73) Assignee: Bobrick Washroom Equipment, Inc.

(21) Appl. No.: 10/886,326

(22) Filed: Jul. 7, 2004

Related U.S. Application Data
(63) Continuation of application No. 10/292,734, filed on Nov. 12, 2002, now abandoned.
Application No. 10/292,734 is a continuation of application No. 09/546,104, filed on Apr. 10, 2000, now Pat. No. 6,502,721.
Application No. 10/292,734 is a continuation of application No. 09/545,126, filed on Apr. 7, 2000, now abandoned.
Application No. 09/545,126 is a continuation-in-part of application No. 09/102,858, filed on Jun. 23, 1998, now Pat. No. 6,129,245.
Application No. 09/102,858 is a continuation-in-part of application No. 08/701,788, filed on Aug. 26, 1996, now Pat. No. 5,988,451.

(51) Int. Cl. B67D 5/08; B67D 5/14; B65D 35/22

(52) U.S. Cl. 222/94

(57) ABSTRACT

A liquid feed system supplies liquid from a collapsible container to at least one liquid dispenser. At least one line couples, in fluid communication, the collapsible fluid container to the at least one liquid dispenser. The liquid feed system may include first and second collapsible containers, with the first collapsible container at an elevation higher than the elevation of the second collapsible container. The first and second collapsible containers are coupled, in fluid communication, to one another and to at least one liquid dispenser by at least one connecting line. Other embodiments of the liquid feed system provide for a series connection between the first and second collapsible containers, and the second collapsible container and the at least one dispenser. In these other embodiments, the first and second collapsible containers are coupled, in fluid communication, by a first connecting line, and the second collapsible container and at least one liquid dispenser are coupled, in fluid communication, by a second connecting line.

### CROSS-REFERENCE TO RELATED APPLICATION(S)

This application is a continuation of U.S. patent application Ser. No. 10/292,734 filed Nov. 12, 2002 which is a continuation of U.S. patent application Ser. No. 09/546,104 filed Apr. 10, 2000, now issued as U.S. Pat. No. 6,502,721, and of U.S. patent application Ser. No. 09/545,126 filed Apr. 7, 2000, each of which is a continuation-in-part of U.S. patent application Ser. No. 09/102,858 filed Jun. 23, 1998, now issued as U.S. Pat. No. 6,129,245, which is a continuation-in-part of U.S. patent application Ser. No. 08/701,788 filed Aug. 26, 1996, now issued as U.S. Pat. No. 5,988,451.

### FIELD OF THE INVENTION

This invention relates to a liquid feed system for dispensing liquids, typically liquid soaps or liquid lotions.

### BACKGROUND OF THE INVENTION

Liquid feed systems for dispensing liquid soap and/or lotion provide convenience for the users of public and semi-public facilities. In addition to convenience, these systems allow individual users to dispense an appropriate amount of liquid to address their needs, thereby reducing waste and further eliminating sanitary concerns that might be introduced with publicly shared supplies, such as, for example, bar soap.

A typical liquid feed system includes a container for the soap and a manually operated valve which may be an off-on valve or a pump valve. Ordinarily the container is mounted directly on the valve structure. A variety of such liquid dispensers are in common use today.

When there are multiple wash basins, a liquid dispenser may be provided with every wash basin. Soap and/or lotion is provided to the liquid dispensers in a variety of manners. For instance, in some systems, each individual liquid dispenser has its own supply container. Dispensing systems utilizing an independent reservoir per liquid dispenser, however, have increased unit costs and maintenance costs.

In another type of liquid feed system, a plurality of liquid dispensers are served from a single container. In one such liquid feed system, sometimes referred to as a gravity soap system, a liquid reservoir is mounted on the wall above a plurality of basins, with a liquid dispenser positioned at each basin and fed by a line from the reservoir. The head pressure of the liquid in the container above the liquid dispensers causes the liquid to flow by gravity into each of the liquid dispensers to fill the valve cavity. Liquid is dispensed by actuating an open-shut valve to empty the valve cavity into the operator's hand. When the valve is closed, the cavity is refilled by the gravity flow from the reservoir. While this system works adequately when the reservoir is positioned directly above the liquid dispensers, it is not satisfactory when the reservoir is positioned at a distance from the liquid dispenser, below the liquid dispenser, or at the same level as the liquid dispenser, as liquid will not flow from the reservoir to the liquid dispenser. Also, of course, it requires that the reservoir be significantly above the liquid dispensers in order to produce the necessary head pressure.

In another configuration, sometimes referred to as an under-the-counter system, the reservoir is positioned directly under the counter. In these liquid feed systems the supply container is coupled to a single line or multiple lines that feed the individual pump-type liquid dispensers mounted above the counter. With this type of construction, the reservoir is filled by removing one of the liquid dispensers and pouring the liquid through the liquid dispenser housing into the reservoir below the counter. After the refill operation, each of the pump liquid dispensers must be primed by repeatedly actuating the pump mechanism. Typically about 75 to 110 strokes are required per liquid dispenser to adequately prime the liquid dispenser to start pumping.

A problem encountered by all of the above mentioned current liquid feed systems is that they fail to provide the liquid in an ongoing manner, namely, they fail to provide a continuous and uninterrupted supply of liquid for the users. Indeed, in situations wherein the liquid dispensers are refilled after they are empty, an interim period exists where some users will not be provided with the liquid. Of course, the supply reservoir can be replenished prior to becoming entirely empty, but this results in increased maintenance costs, and in instances where the supply reservoirs are sealed containers, the remaining liquid is wasted.

Although current liquid feed systems attempt to provide an ample supply of liquid, none of the current liquid feed systems address the issue of providing an economical and continuous, uninterrupted supply of liquid. Existing multiple valve, single reservoir liquid feed systems have several disadvantages. The valves are high cost, designed to withstand a high hydraulic head pressure. The piping system is made of costly metallic pipes either inside the wall, requiring early plumbing, or exposed non-esthetically pleasing plumbing. Also, the soap used has to be a water thin vegetable soap, to run in the pipes and meet the valve design criteria. Such soap, once popular, is now outdated and currently replaced with lotion-type soap, which is much more difficult to draw through the pipes. In addition, these liquid feed systems empty the supply line when the reservoir is empty. Thus, the lines must be reprimed. If the lines are long, more effort is required to reprime them.

Current liquid feed systems have increased maintenance costs and inconvenience to the end users. As such, a need exists in the industry for a liquid feed system that provides a relatively uninterrupted supply of liquid to the users. Further, a need exists for a liquid feed system that does not require repriming of the liquid dispensers if the supply is interrupted once the supply of liquid is replaced. Moreover, a need exists for a liquid feed system that dispenses the lotion-type soaps that are common today over long distances.

### SUMMARY

The liquid feed system of the present invention is designed for use with a sealed, large capacity cleanser reservoir in the form of a flexible or collapsible fluid container. The collapsible fluid container provides the cleanser to a plurality of individual liquid dispensers, which may be attached directly to a wall, a countertop, or other support, with the liquid dispenser pump itself within a housing for improved vandal resistance. Inexpensive flexible tubing connects the collapsible fluid container to the individual liquid dispensers. The liquid feed system utilizes multi-viscosity, low cost, bulk liquid soap from containers which provide a month's supply. Actuation of a pump at the liquid dispenser deposits the liquid directly into the user's hand. The amount of cleanser in the collapsible fluid container can be periodically checked and the container replaced when the content falls to a predetermined level, or the container can be replaced periodically on a scheduled maintenance event.

Preferred embodiments of the invention include a liquid feed system for dispensing a liquid cleanser from a collapsible fluid container, with a plurality of liquid dispensers, each liquid dispenser having a positive displacement pump, and a flexible supply line for connecting the collapsible fluid container to each of the liquid dispensers.

One embodiment of the liquid feed system includes a cabinet with a container support positioned in the cabinet, an access door for removing a used collapsible fluid container and placing a new collapsible fluid container in the container support, and a lock for securing the access door on the cabinet. A nozzle is connected to the collapsible fluid container and a mating cap, coupled to the line, threadably engages the nozzle. In an alternative embodiment the collapsible fluid container may be placed in a remote room.

In another embodiment, the liquid dispensers are mounted on a wall and the supply line is behind the wall. The liquid dispensers may be mounted on a wall above a counter, with the collapsible fluid container supported below the counter, and with the supply line behind the wall, or hidden inside conduits on the wall, between the liquid dispensers and the collapsible fluid container. Alternatively the liquid dispensers may be mounted on a wall in a first room, with the collapsible fluid container in a second room, and with the supply line behind the wall between the liquid dispensers and the collapsible fluid container in the second room. In another alternative embodiment, the liquid dispensers may be mounted on a counter, with the collapsible fluid container under the counter, or in a storage room mounted at a height below the height of the counter.

The presently preferred embodiment of the liquid dispensers of the present invention is that shown in U.S. Pat. No. 5,476,197, which is incorporated by reference herein. In another embodiment of the liquid dispenser, the liquid dispenser includes a tubular casing with an inlet tube as the connection means for slidingly receiving an end of the flexible supply line and with a positive displacement pump slidably inserted into the casing. The positive displacement pump includes a cylinder with a piston cavity, a piston sliding in the piston cavity, an inlet opening in the cylinder for fluid flow from the flexible supply line through the inlet tube into the piston cavity, a spring in the piston cavity for urging the piston outward, a one-way valve positioned between the inlet opening of the cylinder and the spring, another one-way valve positioned between the spring and the piston, with the piston having an outlet flow passage defining a flow path from the flexible supply line through the casing inlet tube, cylinder, and piston cavity to the exterior of the liquid dispenser. Each of the liquid dispensers further include a pin that is fixed in the cylinder and rides in a slot in the piston. The pin permits the piston to slide within the piston cavity while limiting the travel of the piston and preventing piston rotation.

In an alternative embodiment, the liquid feed system includes a first collapsible container, a second collapsible container, and a connecting line, wherein the connecting line couples, in fluid communication, the first collapsible container to the second collapsible container, and further couples, in fluid communication, the first and second collapsible containers to liquid dispensers. The collapsible containers are positioned such that the first collapsible container is placed above the second collapsible container. An advantage of this configuration is that the liquid will fall due to gravity into the second collapsible container such that the additional liquid in the second collapsible container is not diminished, thereby eliminating the need to replace or refill the second collapsible container. Thus, the second collapsible container acts as a reserve to the first collapsible container. When the liquid held in the first collapsible container is depleted, the first collapsible container can be replaced while the second collapsible container remains in the liquid feed system to continuously supply additional liquid to the liquid dispensers without interruption.

The flow of liquid from the first and/or the second collapsible container can be controlled with a one-way valve, an adapter having a shut-off valve, diaphragm-type valve, or other valve that automatically caps off the connecting line when the collapsible container is disconnected from the rest of the liquid feed system. An advantage of this feature is that the connecting line remains filled with liquid, thereby eliminating the problem of repriming the liquid feed system whenever the liquid is replaced. Thus, the liquid feed system provides continuous service and immediate use without the need of repriming.

Liquid from the first and second collapsible containers is drawn into the liquid dispensers via an interconnection of connecting tubes, T-connectors, and elbow connectors. A first connecting tube couples an adapter connected to the first collapsible container to a first T-connector. Also, a second connecting tube couples an adapter connected to the second collapsible container to the first T-connector. A third connecting tube couples the first T-connector to a second T-connector. A fourth connecting tube couples the second T-connector to a first liquid dispenser. A fifth connecting tube couples the second T-connector to an elbow connector. A sixth connecting tube couples the elbow connector to a second liquid dispenser.

In accordance with one aspect of the present invention, a first connecting line couples, in fluid communication, the first collapsible container to the second collapsible container. Also, a second connecting line couples the second collapsible container, in fluid communication, to the liquid dispensers. In a more detailed aspect of the present invention, the first connecting line includes a connecting link adaptor having a first portion and a second portion matable to the first portion. The first portion is coupled, in fluid communication, to the first collapsible container, and the second portion is coupled, in fluid communication, to the second collapsible container. Also, the connecting link adaptor may be a quick-disconnect adaptor.

In another more detailed aspect of the present invention, the first portion of the connecting link adaptor includes a spring-activated shut-off valve that is actuated by connecting and disconnecting the first portion to the second portion. Liquid is permitted to flow through the first portion when the second portion is connected to the first portion, and is prevented from flowing flow out of the first portion when the first and second portions are disconnected. Thus, when the first collapsible container is removed, liquid is prevented from spilling out of the first collapsible container and the first collapsible container can easily be removed for servicing, replacement, or refilling.

In still another more detailed aspect of the present invention, the second portion of the connecting link adaptor includes a diaphragm-type valve that is actuated by connecting and disconnecting the second portion to the first portion. When the first collapsible container is disconnected, liquid is prevented from spilling out of the second collapsible container and air is prevented from entering the second collapsible container. Accordingly, the liquid feed system remains sealed and eliminates the need to reprime the liquid feed system when the first collapsible container is removed.

In another embodiment of the invention, a first connecting line couples, in fluid communication, the first collapsible container to the second collapsible container, and further, a second connecting line couples the second collapsible container, in fluid communication, to liquid dispensers. The second collapsible container includes a conduit strip. The conduit strip is configured with a plurality of conduit channels which provide for the flow of liquid through the second collapsible container even though the second collapsible container is collapsed. Thus, the conduit channels of the conduit strip protect against a blockage of the liquid feed system caused by a collapsed second collapsible container. Therefore, the conduit strip is useful when priming the liquid feed system for the first time and when priming an emptied second collapsible container.

In accordance with one aspect of the present invention, the configuration of the liquid dispensers and the second connecting line are modified. A first dispenser adapter is connected to the base of a first liquid dispenser and a second dispenser adapter is connected to the base of a second liquid dispenser. A first tube couples, in fluid communication, the second collapsible container to an inlet on the first dispenser adapter. A second tube is coupled between an outlet on the first dispenser adapter and an inlet on the second dispenser adapter. A third tube may couple an outlet on the second dispenser adapter to an inlet on a third dispenser adapter, or the outlet on the second dispenser adapter may be capped.

In another more detailed aspect of the present invention, a first container nozzle is connected to the first collapsible container. The first container nozzle is threadably engaged to one end of a first container mating cap. The other end of the first container mating cap couples to the first connecting line.

In a further embodiment of the present invention, in which the first collapsible container is in fluid communication with the second collapsible container, a lid is connected to a port in the second collapsible container. The lid includes an inlet connection tube in fluid communication with the first connecting line and an outlet connection tube, one end of which is in fluid communication with the liquid dispensers via the second connecting line. The other end of the outlet connection tube is coupled, in fluid communication, to a withdrawal tube which extends inside of the second collapsible container. A tube support is connected along the length of the withdrawal tube and positioned between the withdrawal tube and the interior surface of the second collapsible container. Accordingly, the configuration of the withdrawal tube and the tube support requires that the second collapsible container be filled with liquid to the elevation of the withdrawal tube, supported by the tube support, before liquid can flow out of the outlet connection tube.

A feature of the invention is the use of non-collapsible flexible tubing for the connecting lines. An advantage of this feature is that the collapsible containers can be placed in substantially any location without being limited by the placement of the tubing. A further advantage is that the non-collapsible tubing prevents the liquid from being completely drawn out of the line when the collapsible containers are empty, thereby, further eliminating the problem of repriming. Also, the collapsible containers of the instant invention can be of varying volumetric sizes, thus allowing the liquid feed system to accommodate a multitude of space configurations.

Other features and advantages of the present invention will be set forth in part in the description which follows and accompanying drawings, wherein the preferred embodiments of the present invention are described and shown, and in part will become apparent to those skilled in the art upon examination of the following detailed description taken in conjunction with the accompanying drawings, or may be learned by practice of the present invention. The advantages of the present invention may be realized and attained by means of the instrumentalities and combinations particularly pointed out in the appended claims.

### BRIEF DESCRIPTION OF THE DRAWINGS

FIG. 1 is a perspective view illustrating the liquid feed system of the invention with the collapsible fluid container mounted in a room separate from the wash basins and liquid dispensers.

FIG. 2 is a view similar to that of FIG. 1 with the collapsible fluid container mounted underneath the counter.

FIG. 3 is an enlarged sectional view of the preferred embodiment of a liquid dispenser.

FIG. 4 is an enlarged sectional view of a liquid dispenser taken along the line 4-4 of FIG. 2.

FIG. 5 is a view similar to those of FIGS. 1 and 2 with the liquid dispensers mounted on the counter adjacent the basin and the collapsible fluid container mounted underneath the counter.

FIG. 6a is an enlarged view of a portion of FIG. 5 showing the installation of the collapsible fluid container and support box in the cabinet. FIG. 6b depicts an alternative embodiment to FIG. 6a. FIG. 6c is an enlarged partial sectional view taken along line 6-6 of FIG. 6b. FIG. 6d is an enlarged sectional view of the connector of FIGS. 6b and 6c.

FIG. 7 is a schematic of a liquid feed system of the invention with both a first and second collapsible container.

FIG. 8 is an elevational view, partially in section, of an adapter including a piston utilized in the present invention.

FIG. 9 is a perspective view of the piston of FIG. 8.

FIG. 10 is a schematic view of another embodiment of a liquid feed system of the present invention, particularly illustrating a series-bag liquid feed system.

FIG. 11 is a schematic view of another embodiment of the liquid feed system of the present invention, particularly illustrating a second collapsible container with a conduit strip.

FIG. 12A is a sectional view of the second collapsible container and conduit strip of FIG. 11.

FIG. 12B is a top plan view of the conduit strip of FIG. 11.

FIG. 13A is a schematic view of the embodiment of FIG. 11 with a modified liquid dispenser and a second connecting line configuration.

FIG. 13B is a schematic view of the embodiment of FIG. 13A with a modified interface between the first collapsible container and the first connecting line.

FIG. 14 is a schematic view of another embodiment of the liquid feed system of the present invention configured according to the present invention, particularly illustrating a series-bag liquid feed system with a withdrawal tube positioned inside of the second collapsible container.

FIG. 15 is an enlarged cross-sectional view of the withdrawal tube and tube support of FIG. 14.

FIG. 16A is a schematic view of the embodiment of FIG. 14 with a modified liquid dispenser and second connecting line configuration.

FIG. 16B is a schematic view of the embodiment of FIG. 16A with a modified interface between the first collapsible container and the first connecting line.

FIG. 17 is a view similar to FIG. 7 showing an alternate configuration for an auxiliary reservoir and fitting.

### DESCRIPTION OF THE PREFERRED EMBODIMENTS

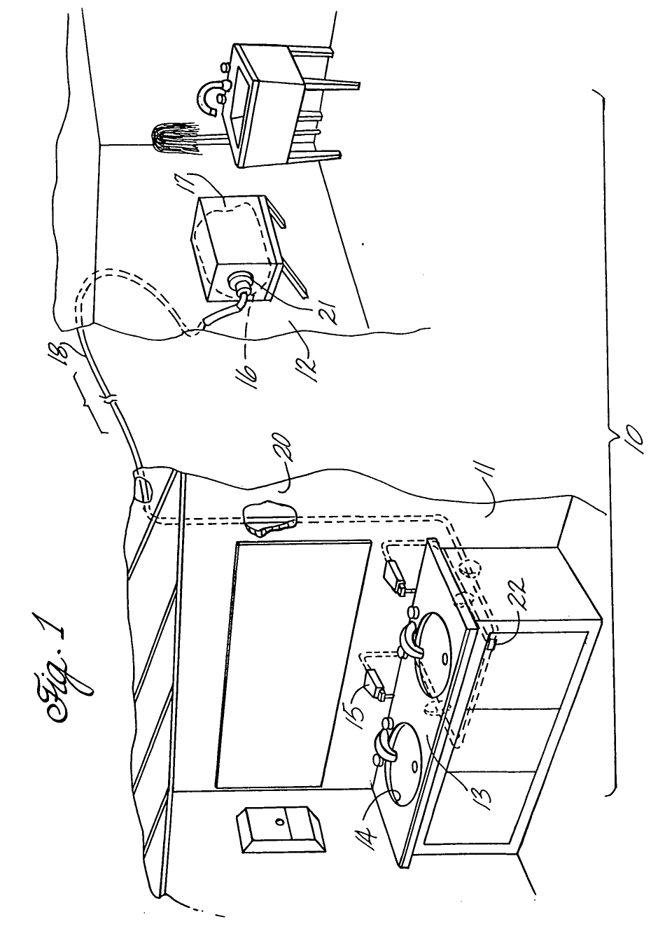

One embodiment of a liquid feed system 10 of the present invention is illustrated in FIG. 1 installed in a washing room 11 and a service room 12. The washing room includes a conventional counter 13 with basins 14 and liquid dispensers 15. A collapsible fluid container 16 is positioned in a support box 17 in the service room, and is connected to the liquid dispensers via a flexible line 18, typically plastic tubing. The collapsible fluid container is located at an elevation below the liquid dispensers. The line has an airtight cap or other connection 21 for connection to the collapsible fluid container, and feeds liquid to each of the liquid dispensers through one or more tee fittings 22. The presently preferred connection for connection 21 is that shown in U.S. Pat. No. 4,564,132, which is incorporated by reference herein.

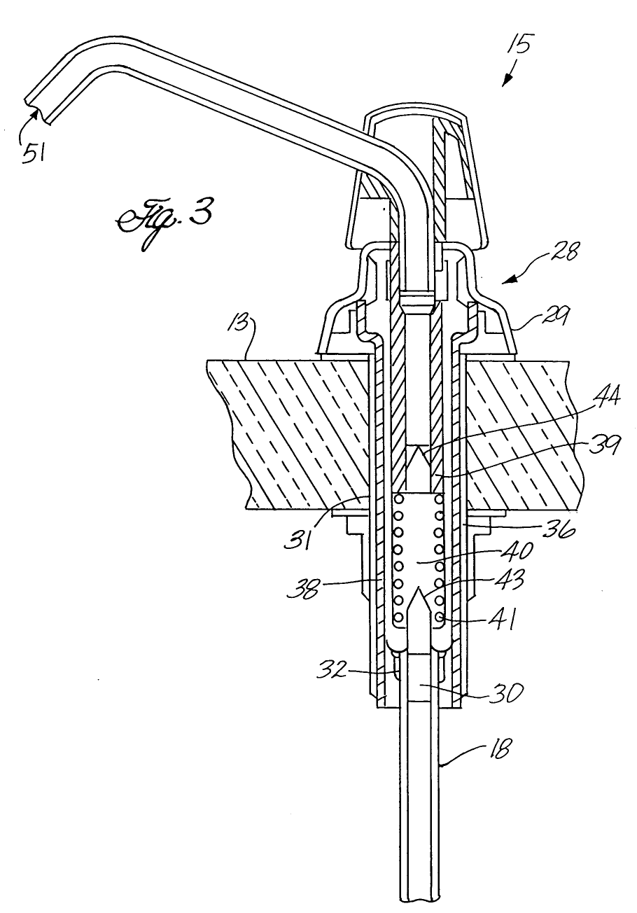

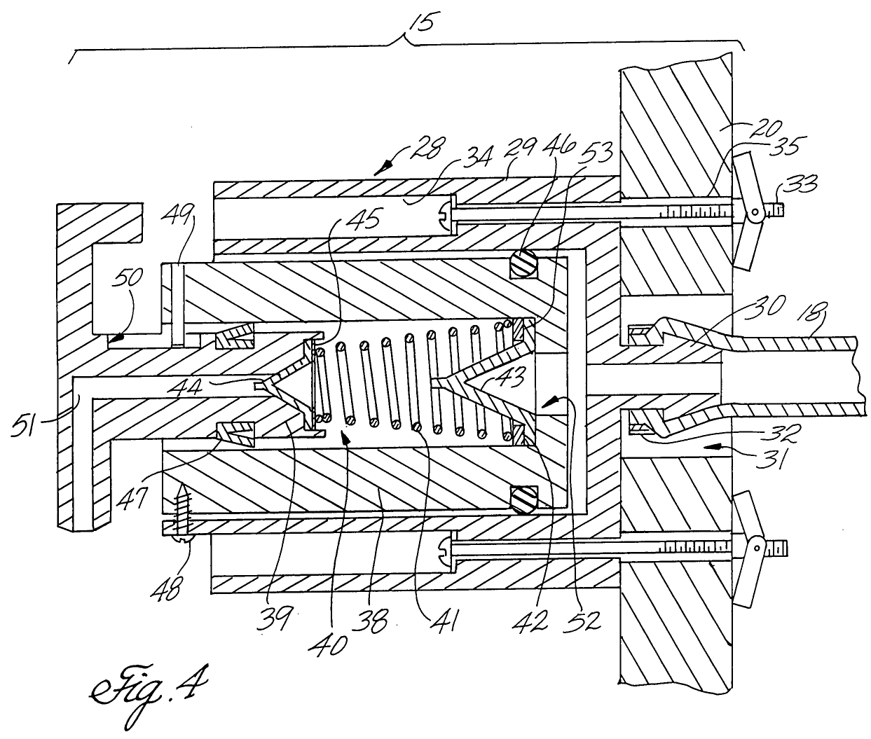

In the embodiment illustrated, the liquid dispensers 15 are mounted on the wall 20 of the washing room 11 in position above and adjacent the basins 14. The line 18 is positioned behind the wall and is connected to the liquid dispensers, as is shown in greater detail in FIGS. 3 and 4. The line runs up the wall and above the hung ceiling of the washing room and onward to the service room 12 for connection to the collapsible fluid container 16. While two liquid dispensers are illustrated, the liquid feed system 10 can be used with one liquid dispenser and with more than two if desired.

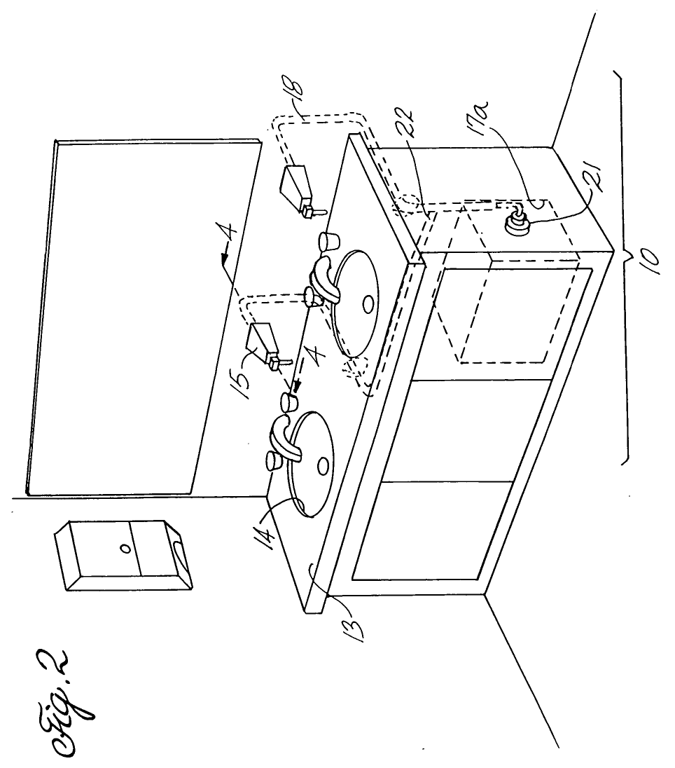

An alternative configuration of the liquid feed system 10 is shown in FIG. 2. Where appropriate, the same reference numerals are used to avoid any unnecessary duplication and description of similar elements already referred to and described above. In FIG. 2, the support box 17a for the collapsible fluid container 16 (now shown) is positioned below the counter 13. In the embodiments of both FIGS. 1 and 2, the support box 17, 17a, respectively, rests on a shelf, or in a cabinet, with or without a locked door, or on another article, or otherwise as desired.

The presently preferred embodiment of the liquid dispenser 15 is illustrated in detail in FIG. 3, however, other configurations for the liquid dispenser may be used. The presently preferred embodiment of the liquid dispenser is that shown in U.S. Pat. No. 5,476,197, which is incorporated by reference herein.

The liquid dispenser 15 of FIG. 3 includes a positive displacement pump 28 which is manually operable or electrically powered, as desired. The liquid dispenser includes a casing 29 which is mounted to the counter 13 with the positive displacement pump positioned in a sleeve 36 within an opening 31 in the counter. The positive displacement pump also includes an inlet tube 30 for connection to the line 18. The line is secured to the inlet tube by a fastener 32.

The positive displacement pump 28 includes a cylinder 38, and a piston 39 that slides within a piston cavity 40 inside of the cylinder. A spring 41 is positioned within the piston cavity. A first one-way valve 43 is positioned between the inlet tube 30 and the spring. A second one-way valve 44 is positioned in the end of the piston nearest the spring. The first and second one-way valves may be conventional in design, such as a duckbill valve or a capsule valve with head holding capacity.

In operation, moving the piston 39 downward, as viewed in FIG. 3, forces liquid from the piston cavity 40 out through the second one-way valve 44 and a passage 51 through the piston into the user's hand. When the pressure on the piston is released, the spring 41 moves the piston upward drawing liquid from the line 18 through the inlet tube 30 and into the piston cavity via the first one-way valve 43.

The liquid dispenser 15 of the present invention is capable of other and different embodiments, and its several details are capable of modification. For example, another embodiment of a liquid dispenser configured according to the present invention is shown in FIG. 4. Where appropriate, the same reference numerals are used to avoid unnecessary duplication and description of similar elements already referred to and described above.

In the alternative embodiment shown in FIG. 4, the liquid dispenser includes a tubular casing 29 with an inlet tube 30 at one end for connection to the line 18. The casing is mounted on the wall 20 with the inlet tube positioned in an opening 31 in the wall. The end of the line is fastened on the inlet tube by a fastener 32. The casing is mounted on the wall by toggle bolts or screws or other fasteners 33 positioned in aligned openings 34 in the casing and aligned openings 35 in the wall. The openings are parallel with each other and perpendicular to the wall.

Each liquid dispenser 15 includes a positive displacement pump 28 which is manually operable or electrically powered, as desired. Also, the positive displacement pump may be a liquid pump or a lather pump as desired. The positive displacement pump includes a cylinder 38 with a piston 39 sliding in a piston cavity 40 inside of the cylinder. The cylinder includes a cavity wall 53 with an opening 52. A spring 41 is positioned in the piston cavity. A first washer 42 is positioned within the piston cavity between the spring and a first one-way valve 43. A second washer 45 is positioned within the piston cavity between the spring and a second one-way valve 44. A seal ring 46 is positioned on the cylinder for sealing engagement with the interior wall of the casing 29. Another seal ring 47 is provided in the piston for sealing engagement with the interior wall of the cylinder. A fastener, such as a screw 48, provides for connecting the positive displacement pump to the casing. A pin 49 is fixed in the cylinder and rides in a slot 50 in the piston, permitting sliding of the piston in the cylinder while limiting the piston travel and preventing piston rotation, thereby keeping the soap outlet downwards.

In operation, moving the piston 39 inward or to the right as viewed in FIG. 4, forces liquid from the piston cavity 40 out through the second one-way valve 44 and a passage 51 through the piston into the user's hand. When the inward pressure on the piston is released, the spring 41 moves the piston outward, to the left as viewed in FIG. 4, which motion draws liquid from the line 18 through the inlet tube 30, through the opening 52 in the cavity wall 53 of the cylinder 30, and through the first one-way valve 43 into the piston cavity.

Since the liquid dispenser 15 does not operate with gravity flow, a construction of the liquid dispenser for preventing leakage at high head pressures it not required. The liquid dispenser as disclosed has a low cost simple construction. The cylinder 38 and piston 39 may be plastic molded parts and the rest of the entire positive displacement pump 28 requires only the spring 41, washers 42, 45, two one-way valves 43, 44, seal rings 46, 47, and the retaining screw 48 and pin 49.

The casing 29 itself should be made from a high strength material to reduce damage due to vandalism. The casing typically is chrome plated die cast zinc for both durability and strength. Alternatively, a plated strong plastic material is used for the casing.

The line 18 is typically a flexible non-collapsible plastic tubing which is readily installed after the walls of the washing and service rooms are constructed.

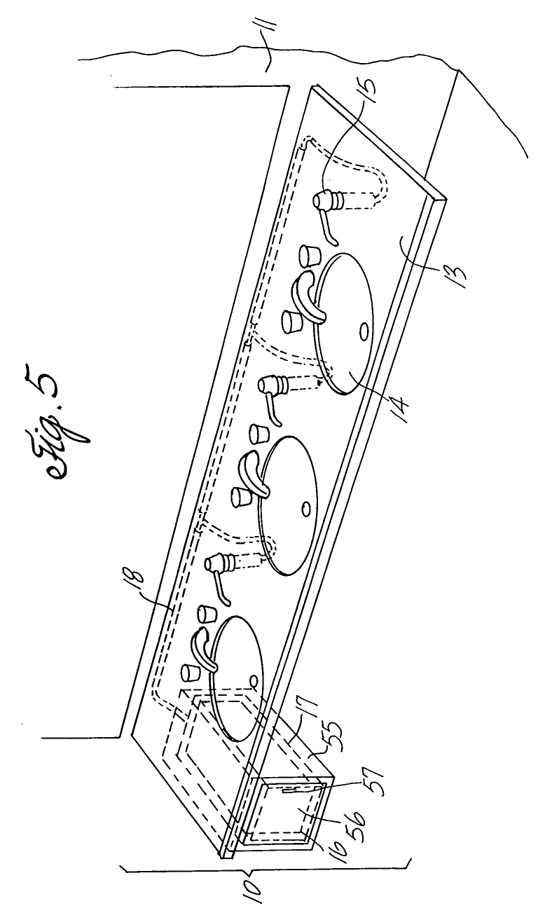

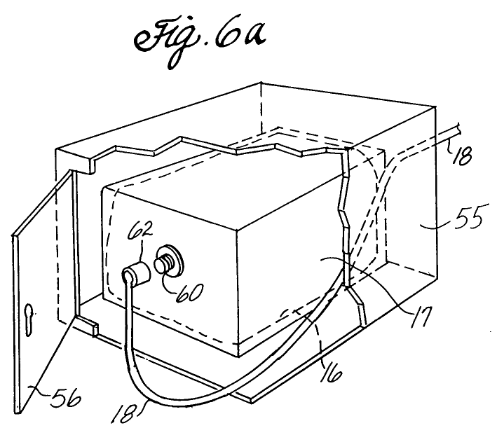

In the embodiment shown in FIGS. 5 and 6, components corresponding to those of the earlier figures are identified by the same reference numerals to avoid unnecessary duplication and description of similar elements already referred to and described above. In this embodiment, the liquid dispensers 15 are mounted on the counter 13, and a cabinet 55 is mounted underneath the counter for receiving the collapsible fluid container 16 and the support box 17. The cabinet has a hinged door 56 with a locking latch 57 for controlling access to the cabinet.

In this embodiment, as illustrated in FIG. 6a, a nozzle 60 is carried on the support box 17 for connection to the collapsible fluid container 16. The line 18 is connected to one end of a mating cap 62, and the opposing end of the mating cap threadably engages the nozzle. While any nozzle and mating cap may be utilized, the presently preferred nozzle and mating cap are those of connection 21 in FIG. 1.

In an alternative embodiment illustrated in FIGS. 6b-6d, an outlet nozzle 60′ is carried in the support box 17′ for connection to the container 16′. A lever control valve 61′ may be affixed in the nozzle for controlling flow.

The flexible line 18′ is connected to the nozzle 60′ by a coupling 62′ with a J-shaped slot 63′ for engaging a pin 64′ at the outer end of the nozzle 60′. Typically a gasket 65′ is positioned in the coupling 62′ for sealing engagement with the end of the nozzle 60′.

A one-way valve 23′ may be positioned in the line 18′ in a fitting 24a′, with this fitting connected between portions 18a′ and 18b′ of the line by conventional barbed projections 66′.

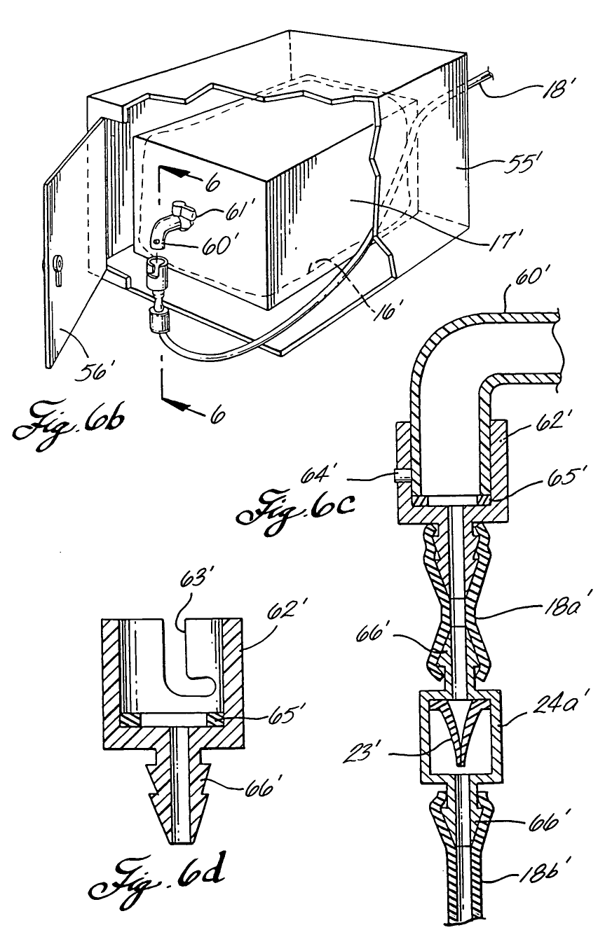

With reference to FIG. 7, an alternative embodiment of a liquid feed system 10 of the present invention is shown. The liquid feed system includes a main reservoir 102, an auxiliary reservoir 104, a connecting line 105, and two liquid dispensers 15.

The main reservoir 102 includes a carton 107 having a top end 108, a bottom end 110 and a hollow interior 112. In practice, the main reservoir is positioned at an elevation below the elevation of the liquid dispensers 15. A first collapsible container 114 is disposed within the carton. The carton includes a carton outlet 116 and a first outlet nozzle 117 through which liquid from the first collapsible container passes. The outlet nozzle is mounted in the carton outlet by conventional means, which permit the first outlet nozzle to rotate to achieve any desired orientation, e.g., vertically or horizontally.

The carton 107 is made from heavy cardboard, or any other material suitable for supporting therein a full soap container. In one embodiment, the main body of the carton is rectangular, although any shape which facilitates stable storage is suitable. In some embodiments, the carton further includes a handle 119 which is disposed on the top end 108 of the carton and a detachable box-end (not shown) for protection of the first nozzle 117.

The first collapsible container 114 is made from a sturdy plastic material, although any nonpermeable material is suitable. In addition the first collapsible container can be made from “bacteria resistant” or antibacterial material such that microbes, spores or other germs or bacteria do not cultivate within the liquid.

The first collapsible container 114 is connected to a first outlet nozzle 117, with a first outlet lever control valve 120 such as an on/off valve, which is well known in the art. The first outlet lever control valve controls the flow of the liquid from the first collapsible container through the first outlet nozzle. The first outlet nozzle is coupled to an outlet 122 of the first collapsible container, e.g., by welding, and is made from sturdy material, such as, but not limited to plastics or metal, although any material capable of facilitating the flow of liquids such as lotion-type soap or other similar liquids more viscous than water is suitable.

The auxiliary reservoir 104 is disposed below the main reservoir 102 and includes a second collapsible container 115, having a second outlet nozzle 118. The second collapsible container and the second outlet nozzle are of the same type as used in the main reservoir. The second collapsible container need not be encased in a carton since it is replaced less often than the first collapsible container 114. The main and auxiliary reservoirs are placed on shelving or any other type of storage unit to protect the main and auxiliary reservoirs from being distributed or falling over. Typically, the auxiliary reservoir is placed between two shelves such that it is protected and the main reservoir resides on the shelf (not shown) above the auxiliary reservoir. The use of both the main and auxiliary reservoirs allows the main reservoir to be replaced when empty without affecting the supply of liquid to the end users as the auxiliary reservoir continues supplying additional liquid to the users. Preferably, a second outlet lever control valve 121 of the auxiliary reservoir, if provided, remains in the open position at all times, as the auxiliary reservoir need not be changed.

The first and second collapsible containers 114, 115 can accommodate any volumetric size. In one embodiment, the first collapsible container stores about 12 liters of liquid, and the second collapsible container is smaller and stores about 3 liters of additional liquid. The volumetric size of the main and auxiliary reservoirs 102, 104 is limited, in part, only by practical considerations, such as, for example, storage size and weight of the main and auxiliary reservoirs with the liquid. However, any varying sizes conducive to conveniently supplying liquid to end users is suitable.

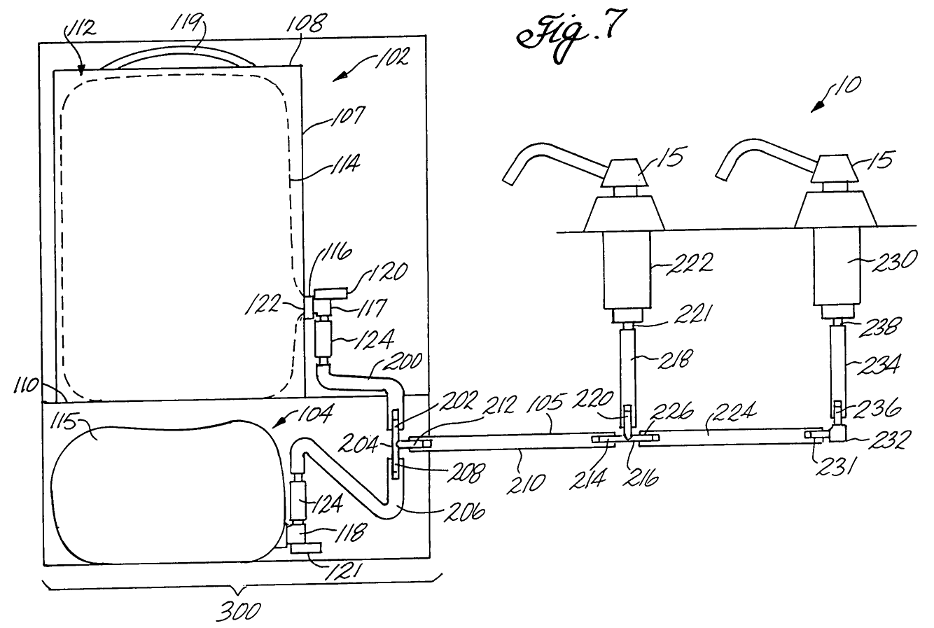

An adapter 124 is mounted to the first and second outlet nozzles 117, 118 of the first and second collapsible containers 114, 115, respectively. With reference to FIG. 8, the adapter includes a housing 126, and a piston 128. The housing 126 has a substantially cylindrical portion 130 having a first end 132, an opposing second end 134, and a barbed outlet 135. The first end of the cylindrical portion is open and is sized to receive the first or second outlet nozzle 117, 118. The first end further includes a J-shaped channel 136 that is configured to receive a nozzle pin 138 to form a bayonet-type connection such that the adapter and either the first or second outlet nozzle are coupled together. The second end of the cylindrical portion forms an annular wall 140.

The barbed outlet 135 of the adapter 124 extends from the second end 134 of the cylindrical portion 130 of the housing 126 and includes a hollow body 142 having a bore 143 and an outer barbed surface 144. The interior of the barbed outlet includes a flared opening 146 that widens toward the interior of the cylindrical portion. The cylindrical portion and the barbed outlet of the housing are manufactured as a unitary piece. The outer barbed surface facilitates coupling to a plastic tube. Other surface configurations, or other means capable of securing a tube to the adapter, such as a clamp, however, are also suitable.

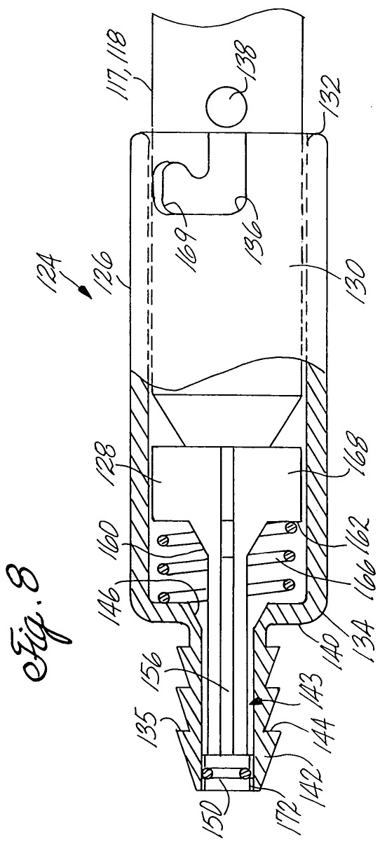

With reference also to FIG. 9, the piston 128 includes a shaft 148 having a plug 150 mounted at one of the opposing ends of the shaft. The shaft includes four ribs 152 that come together at their inner ends to form the shape of a cross. Each rib has a first end portion 154 that extends longitudinally from the plug 150 and has a width slightly smaller than the radius of the bore 143 of the barbed outlet 135 such that the first end portions of the four ribs form a cross-shaped first end portion 156 that fits within the bore of the barbed outlet and provides flow passages between the ribs through the barbed outlet.

Each rib 152 also has a tapered portion 158 that flares out from the first end portion 154. The four tapered portions form a cross-shaped tapered portion 160 that mates with the flared opening 146 of the housing 126. Further, each rib has a radially extending shoulder portion 162 and a second end portion 164. As shown in FIG. 8, a spring 166 is located between and engages the radial extending shoulder portions of the ribs and the annular wall 140 of the housing to bias the piston 128 towards the first end 132 of the cylindrical portion 130 of the housing.

The second end portions 164 of the four ribs 152 form a cross-shaped second end portion 168 that closely fits within the cylindrical portion 130 of the housing 126 and provides flow passage between the ribs and the cylindrical portion.

The plug 150 is a disc-shaped member that fits within the bore 143 of the barbed outlet 135. A peripheral groove 170 in the plug receives an O-ring 172 to form a seal between the plug and the bore of the barbed outlet to prevent liquid from leaking out of the adapter 124. The shaft 148 and the plug can be manufactured as a single unitary piece.

The adapter 124 is mounted, for example, to the first outlet nozzle 117 of the first collapsible container 114 by placing it over the end of the first outlet nozzle such that the nozzle pin 138 of the first outlet nozzle enters the J-shaped channel 136 of the adapter. As the adapter is mounted to the first outlet nozzle, the end of the first outlet nozzle engages the cross-shaped second end portion 168 of the piston 128 and slides it downward, disengaging the O-ring 172 from the bore 143 of the barbed outlet 135, permitting liquid to flow through the adapter when the first outlet lever control valve 120 is opened. The adapter is secured to the first outlet nozzle by rotating the adapter such that the nozzle pin of the first outlet nozzle is located in the circumferentially extending portion 169 of the J-shaped channel. Notably, when it is time to replace an empty first collapsible container with a full container, the adapter is disengaged from the first outlet nozzle and the plug 150 of the piston automatically retracts into the bore of the adapter due to the biasing action of the spring 166. This prevents liquid from the liquid dispenser 15 and connecting line 105 from leaking back out through the adapter. Similarly, the adapter may be mounted to the second outlet nozzle 118 of the second collapsible container 115.

It is to be appreciated that in some embodiments, the auxiliary reservoir 104 need not utilize the adapter 124, but rather the second outlet nozzle 118 may be modified such that it directly couples with the connecting line 105. As stated above, there is less of a need to be able to control the flow of liquid into the auxiliary reservoir as it is not changed as often as the main reservoir 102.

With reference again to FIG. 7, a first connecting tube 200 is coupled between the adapter 124 on the main reservoir 102 and a first inlet 202 of a first T-connector 204. A second connecting tube 206 is coupled between the adapter on the auxiliary reservoir 104 and a second inlet 208 of the first T-connector. A third connecting tube 210 is coupled between an outlet 212 of the first T-connector and a first inlet 214 of a second T-connector 216. A fourth connecting tube 218 is coupled between a first outlet 220 of the second T-connector and an inlet 221 to a first liquid dispenser 222. A fifth connecting tube 224 is coupled between a second outlet 226 of the second T-connector and an inlet 228 to a second liquid dispenser 230. Alternatively, the fifth connecting tube may be coupled between the second outlet of the second T-connector and an inlet 231 of an elbow connector 232, and a sixth connecting tube 234 may be coupled between an outlet 236 of the elbow connector to the inlet of the second liquid dispenser. All of the connecting tubes are made from a flexible material that does not collapse during use. It will also be appreciated that many different types of fittings, such as tees, elbows, cross fittings, etc. may be used depending on the application. In addition, reducers may be inserted in the connecting tubes to connect any size collapsible container to any size liquid dispenser.

In practice, once the main and auxiliary reservoirs 102, 104 are located in a facility, e.g., a restroom, the adapters 124 are connected to the first and second outlet nozzles 117, 118 of the first and second collapsible containers 114, 115, respectively, and the liquid dispensers 15 are initially primed such that liquid fills the connecting tubes 200, 206, 210, 218, 224, 234. When an end user operates a liquid dispenser, liquid is drawn from the connecting tubes through the liquid dispenser and into the end user's hands.

Typically, due to gravity, liquid from the main reservoir 102 moves downward into the auxiliary reservoir 104 such that the auxiliary reservoir remains full of additional liquid. The liquid is drawn from both the main and auxiliary reservoirs through the first T-connector 204 via the first connecting tube 200 and the second connecting tube 206. The liquid is drawn through the first T-connector and traverses the connecting tubes 210, 218, 224, 234 until it reaches the liquid dispensers 15.

Typically, the main reservoir 102 will empty before the auxiliary reservoir 104. After the main reservoir is empty, maintenance personnel will disconnect the adapter 124 from the first outlet nozzle 117 on the main reservoir and remove the main reservoir from the location. As the adapter is removed from the first outlet nozzle, the piston 128 (FIG. 8) slides toward the first end 132 of the housing 126 such that the O-ring 172 retracts and seals the bore 143 of the barbed outlet 135, and thereby preventing any back flow of the liquid out of the first connecting tube 200 and adapter. Removal of the main reservoir does not affect operation of the liquid feed system 10. Rather, the liquid dispensers 15, when operated, begin drawing additional liquid from the auxiliary reservoir until such time that the main reservoir has been replaced. Thus, the end user is unaware of the removal of the main reservoir. Finally, the main reservoir is replaced and the auxiliary reservoir is replenished from the main reservoir by gravity. The auxiliary reservoir allows for continuation of service even if the main reservoir is empty and while the main reservoir is being replaced.

If the demand for liquid exceeds capacity, and both the main and auxiliary reservoirs 102, 104 become empty, the liquid dispensers 15 will stop delivering liquid but the connecting tubes 200, 206, 210, 218, 224, 234 will remain filled with liquid that cannot be dispensed since the first and second collapsible containers 114, 115 are airtight. Therefore, the liquid feed system 10 will remain primed. This is a feature that allows immediate dispensing from the liquid dispensers as soon as the empty main and auxiliary reservoirs are replaced, provided both the main and auxiliary reservoirs are connected to an adapter 124 that seals the end of the first and second connecting tubes 200, 206 as each reservoir is replaced. After replacement of the main and auxiliary reservoirs, the newly supplied liquid simply allows the liquid already in the connecting tubes to be dispensed first.

The construction of the invention readily permits the use of large capacity fluid containers, including the twelve and twenty-four liter containers now used for soap supplies. The ability to replace the first and second collapsible containers 114, 115, is a maintenance time saving feature since no bulk soap is poured and possibly spilled, and only one container need be replaced to fill multiple liquid dispensers 15.

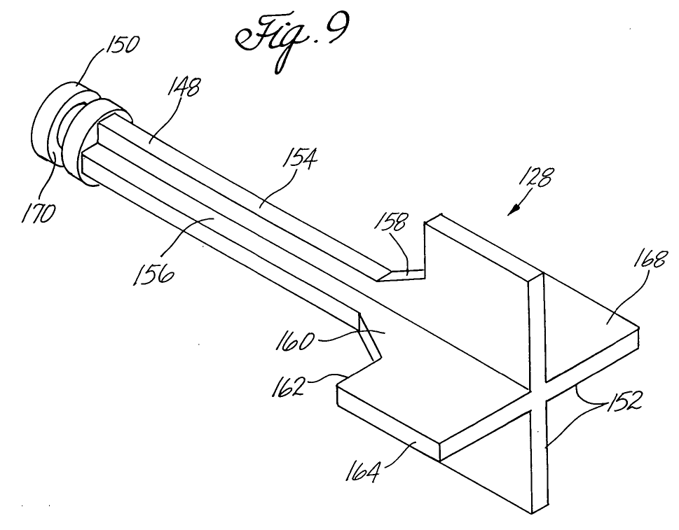

The present invention is capable of other and different embodiments, and its several details are capable of modification. For example, another embodiment of a liquid feed system 10 configured according to the present invention is shown in FIG. 10. Where appropriate the same reference numerals are used to avoid unnecessary duplication and description of similar elements already referred to and described above. Only the significant differences of the embodiment will be discussed hereafter.

A series-bag liquid feed system 300 supplies liquid, such as, soap or lotion, to liquid dispensers 15. The liquid feed system 300 primarily comprises a first collapsible container 114, a second collapsible container 115 which has a wall 314 and an interior surface 316, a first connecting line 301 that couples, in fluid communication, the first collapsible container to the second collapsible container, and a second connecting line 303 which couples, in fluid communication, the second collapsible container to the liquid dispensers.

The first collapsible container 114 is at an elevation that is below the elevation of the liquid dispensers 15 and above the elevation of the second collapsible container 115 such that the liquid is drawn from the first collapsible container, through the first connecting line 301, and into the second collapsible container. Thus, the second collapsible container holds additional liquid and acts as a reserve to the first collapsible container. When the liquid held in the first collapsible container is depleted, the first collapsible container can be replaced while the second collapsible container remains connected, to continuously supply liquid to the liquid dispensers without interruption.

In a detailed aspect of the present embodiment of the invention, the first connecting line 301 includes a connecting link adaptor 302 having a first portion 304 and a second portion 306 matable to the first potion. The first portion is coupled, in fluid communication, to the first collapsible container 114, and the second portion is coupled, in fluid communication, to the second collapsible container 115. The connecting link adaptor can be a high-flow quick-disconnect adaptor of a type commercially available, such as, model number HFCD176-12 for the first portion (base with quick release) and model number HFCD226-12 for the second portion (mating portion) manufactured by Colder Products Company and distributed by Ryan Herco of Burbank, Calif.

Use of the connecting link adaptor 302 allows for easy removal of the first collapsible container 114 for servicing, replacement, or refilling. Further, the connecting link adaptor as used in this embodiment eliminates the need for certain parts used in other embodiments, such as, an adaptor 124 for the second collapsible container 115, a T-connector 204, and a second outlet lever control valve 121 for the second collapsible container.

The first portion 304 of the connecting link adaptor 302 can include a diaphragm-type valve that is actuated by connecting and disconnecting the first portion to the second portion 306. Liquid is permitted to flow through the first portion when connected to the second portion, and prevented from flowing out of the first portion when disconnected from the second portion. Thus, when the first collapsible container 114 is removed, liquid is prevented from spilling out of the first collapsible container.

The second portion 306 of the connecting link adaptor 302 can also include a spring-actuated shut-off valve that is actuated by connecting and disconnecting the second portion to the first portion 304. When the first collapsible container 114 is removed, the spring-actuated shut-off valve prevents liquid from spilling out of the second collapsible container 115 and air from entering the second collapsible container. Accordingly, the liquid feed system 10 remains sealed and eliminates the need to reprime the liquid feed system when the first collapsible container is removed.

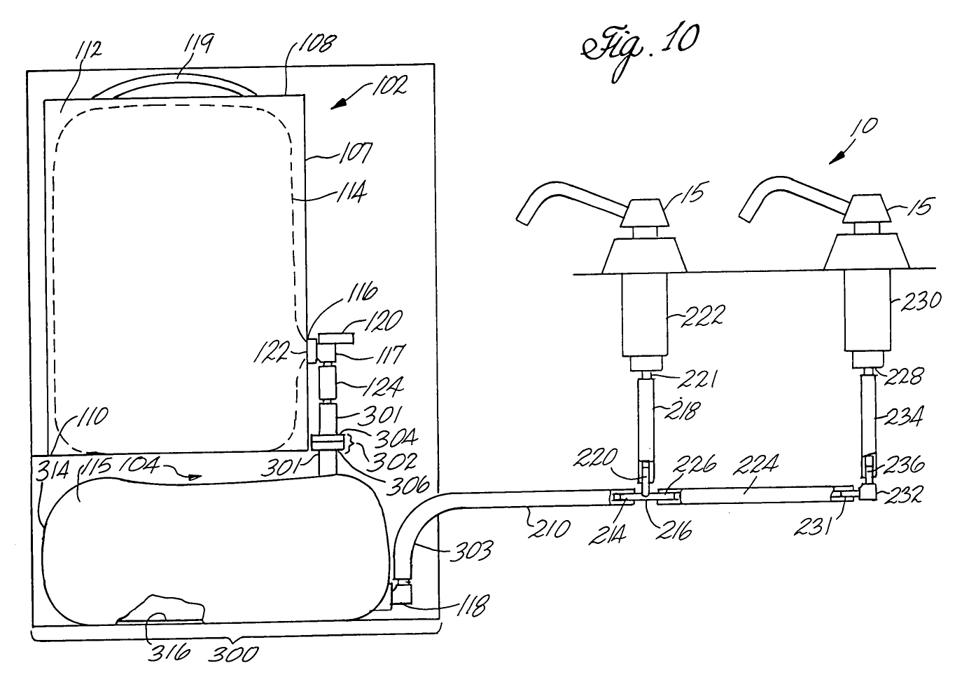

Another embodiment of the present invention is shown in FIG. 11. Where appropriate the same reference numerals are used to avoid unnecessary duplication and description of similar elements already referred to and described above. Only the significant differences of the embodiment will be discussed hereafter.

The embodiment of the series-bag liquid feed system 300, shown in FIG. 11, primarily comprises a first collapsible container 114, a second collapsible container 115, a first connecting line 308, a second connecting line 303, and two liquid dispensers 15.

The first collapsible container 114 is at an elevation below the liquid dispensers 15 and above the second collapsible container 115, which holds additional liquid and acts as a reserve to the first collapsible container. Similar to the previous embodiment, when the first collapsible container is empty, the first collapsible container can be replaced without removing the second collapsible container from the series-bag liquid feed system 300.

The second collapsible container 115 includes a wall 314, an interior surface 316, an inlet nozzle 319, and an outlet nozzle 321. Both the inlet and outlet nozzles are connected to the wall of the second collapsible container and positioned at opposite ends of the second collapsible container.

The first connecting line 308 includes a first end 310 and a second end 312. The first end of the first connecting line is coupled, in fluid communication, to the first collapsible container 114 via an adapter 124, and the second end is coupled, in fluid communication, to one end of an inlet mating cap 318. The opposing end of the inlet mating cap threadably engages the inlet nozzle 319. The second connecting line 303 couples, in fluid communication, one end of an outlet mating cap 320 to the liquid dispensers 15. The opposing end of the outlet mating cap threadably engages the outlet nozzle 321.

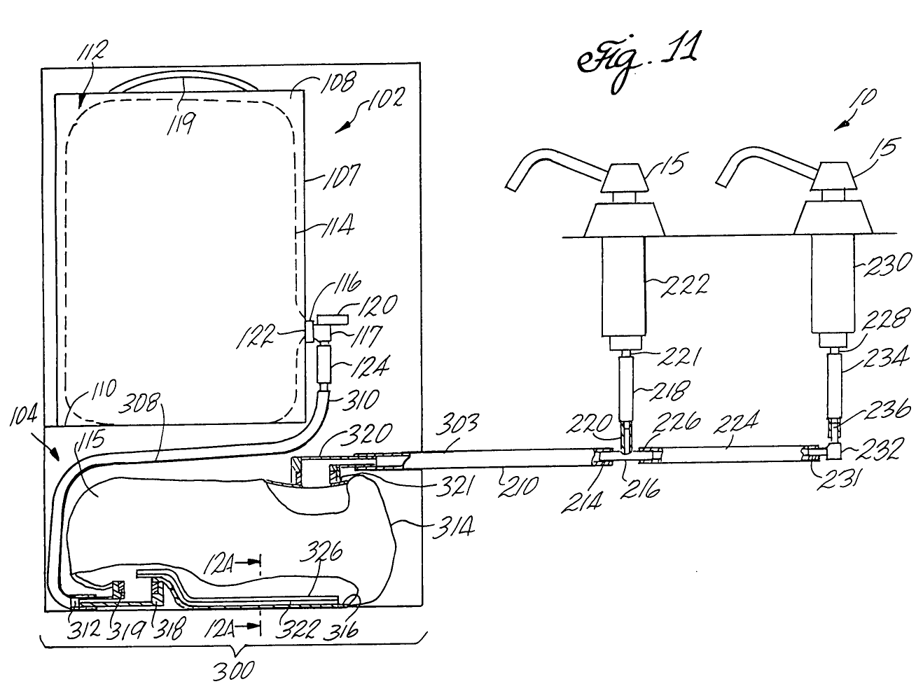

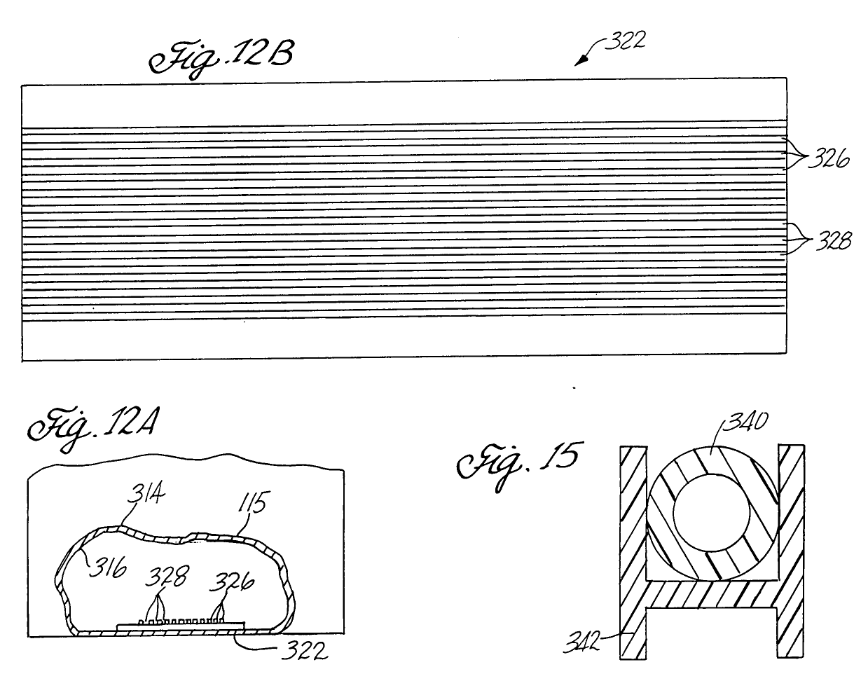

The conduit strip 322 includes a plurality of conduit ridges 326 and a plurality of conduit channels 328, as shown in FIGS. 12A and 12B. Each conduit channel is defined by a pair of conduit ridges. The conduit strip is bonded, preferably with tape, to the interior surface 316 of the second collapsible container 115. The conduit strip is positioned such that when the second collapsible container is collapsed the outlet nozzle 321 is adjacent to one end of the conduit strip while the opposing end of the conduit strip overlaps the inlet nozzle 319.

The conduit channels 328 prevent clogging of the outlet nozzle 321 when the second collapsible container 115 is collapsed. If a second collapsible container, without a conduit strip, is collapsed there exists a possibility that the outlet nozzle would come in contact with the interior surface 316 of the second collapsible container. If a user attempts to actuate the liquid dispenser 15 when the outlet nozzle is in contact with the interior surface of the second collapsible container, a vacuum could develop in the second connecting line 303. This vacuum would help to maintain the contact between the outlet nozzle and interior surface of the second collapsible container and cause a blockage of the series-bag liquid feed system 300 resulting in no flow or a reduced flow of liquid to the liquid dispensers.

In contrast, a collapsed second collapsible container 115, configured with the conduit strip 322, would have a reduced likelihood of blockage because the conduit ridges 326 would contact the outlet nozzle 321, and the conduit channels 328 would allow for liquids, such as, soap or lotion, to flow through the outlet nozzle and into the second connecting line 303. The protections against blockage of the series-bag liquid feed system 300 provided by the conduit strip are useful when priming the liquid feed system 10 for the first time and when priming an emptied second collapsible container.

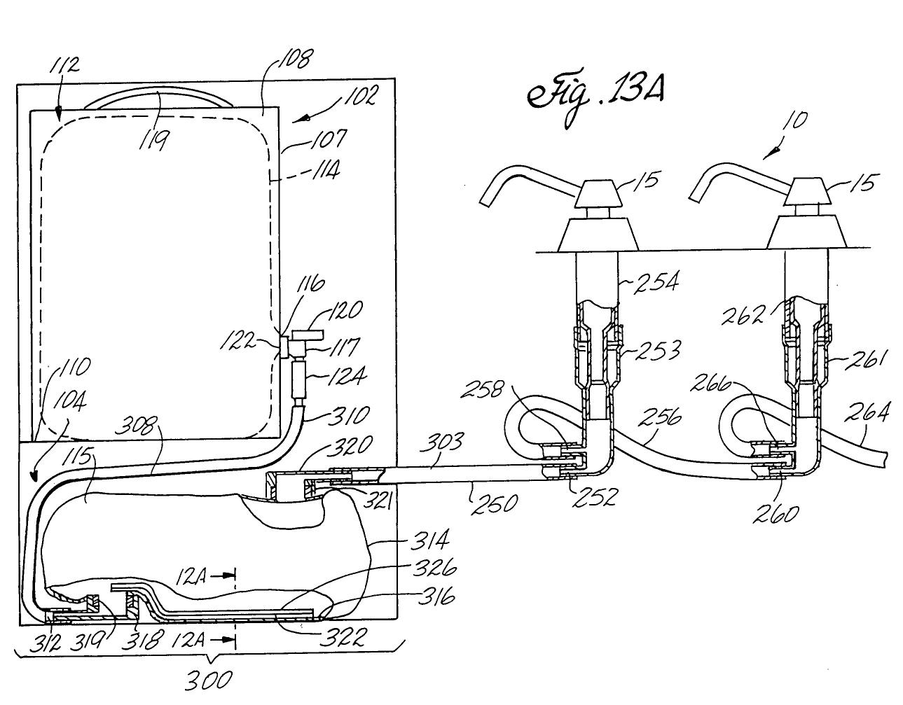

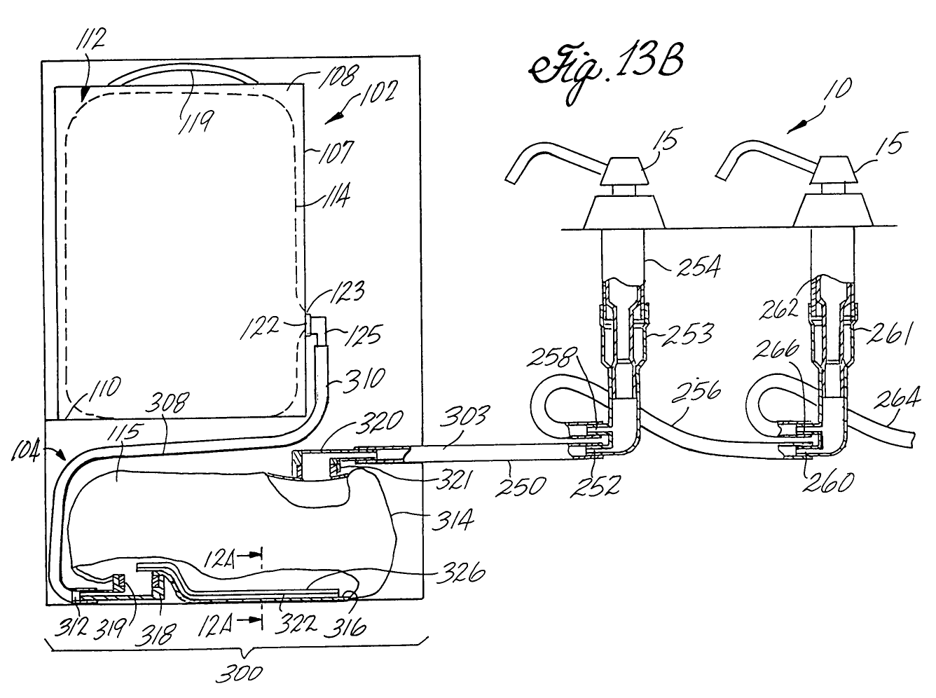

FIG. 13A is a depiction of another embodiment of the invention shown in FIG. 11. Where appropriate the same reference numerals are used to avoid unnecessary duplication and description of similar elements already referred to and described above. Only significant differences of the embodiment will be discussed hereafter. In FIG. 13A, the configuration of the liquid dispensers 15 in FIG. 13A is modified from that of FIG. 11. FIG. 13A shows a first dispenser adapter 253 connected to the base of a first liquid dispenser 254. Similarly, a second dispenser adapter 261 is connected to the base of a second liquid dispenser 262. Also, the second connecting line 303 has a modified configuration. With reference to FIG. 13A, a first tube 250 is coupled between the outlet mating cap 320 and an inlet 252 of the first dispenser adapter. A second tube 256 is coupled between an outlet 258 of the first dispenser adapter and an inlet 260 of the second dispenser adapter. A third tube 264 may be coupled between an outlet 266 of the second dispenser adapter and an inlet (not shown) of a third dispenser adapter (not shown). If a third tube is not utilized, the outlet of the second dispenser adapter is sealed with a cap (not shown).

In operation, the liquid dispensers 15 draw liquid from the second collapsible container 115 via the first tube 250. Specifically, a user of the first liquid dispenser 254 draws liquid from the first tube into the first liquid dispenser via the inlet 252 of the first dispenser adapter 253. A user of the second liquid dispenser 262 draws liquid from the outlet 258 of the first dispenser adapter into the second liquid dispenser via the second tube 256 and the inlet 260 of the second dispenser adapter 261.

FIG. 13B is a depiction of another embodiment of the invention shown in FIG. 13A. Where appropriate the same reference numerals are used to avoid unnecessary duplication and description of similar elements already referred to and described above. Only significant differences of the embodiment will be discussed hereafter. In FIG. 13B, the first collapsible container 114 is disposed within the carton 107. A first container nozzle 123 is carried on the carton and is coupled to the outlet 122 of the first collapsible container. One end of a first container mating cap 125 threadably engages the first container nozzle, and the opposing end of the first container mating cap is connected to the first end 310 of the first connecting line 308. While any nozzle and mating cap may be utilized, the presently preferred nozzle and mating cap for the first container nozzle and first container mating cap are those of connection 21 in FIG. 1.

When the first container mating cap 125 engages the first container nozzle 123, liquid flows from the first collapsible container 114 through the first container nozzle and first container mating cap into the first connecting line 308. In contrast, when the first container mating cap is disengaged from the first container nozzle, the flow of liquid out of the first collapsible container stops and the first connecting line remains sealed.

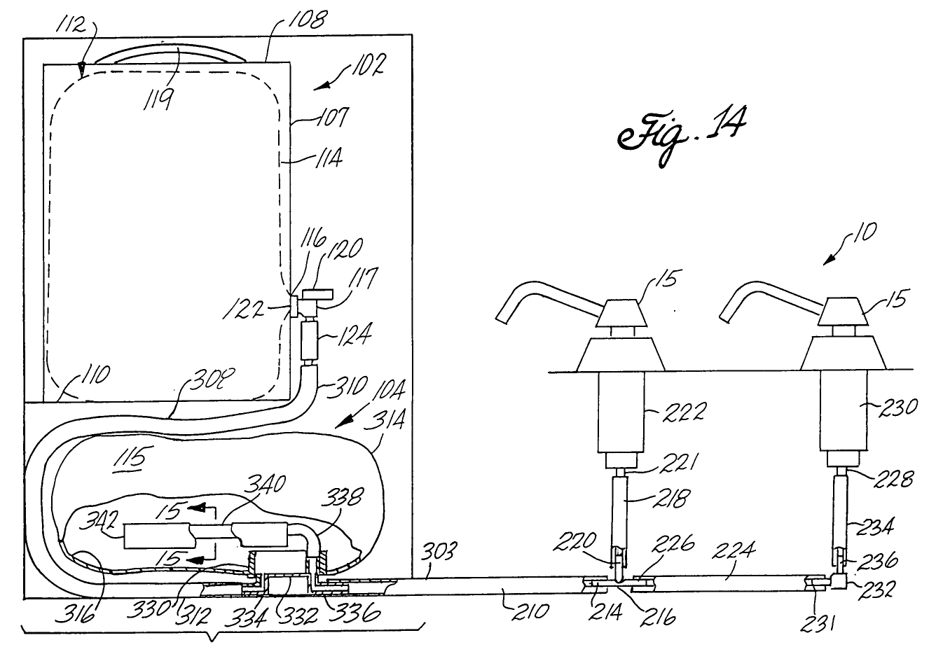

A further embodiment of the present invention is shown in FIG. 14. Where appropriate the same reference numerals are used to avoid unnecessary duplication and description of similar elements already referred to and described above. Only the significant differences of the embodiment will be discussed hereafter.

The embodiment of the series-bag liquid feed system 300, shown in FIG. 14, similar to the embodiment of FIG. 11, primarily comprises a first collapsible container 114, a second collapsible container 115, a first connecting line 308, a second connecting line 303, and two liquid dispensers 15.

As stated in the embodiment of FIG. 11, the first collapsible container 114 is at an elevation below the liquid dispensers 15 and above the second collapsible container 115, which holds additional liquid and acts as a reserve to the first collapsible container. Also, the first collapsible container can be replaced without removing the second collapsible container from the series-bag liquid feed system 300.

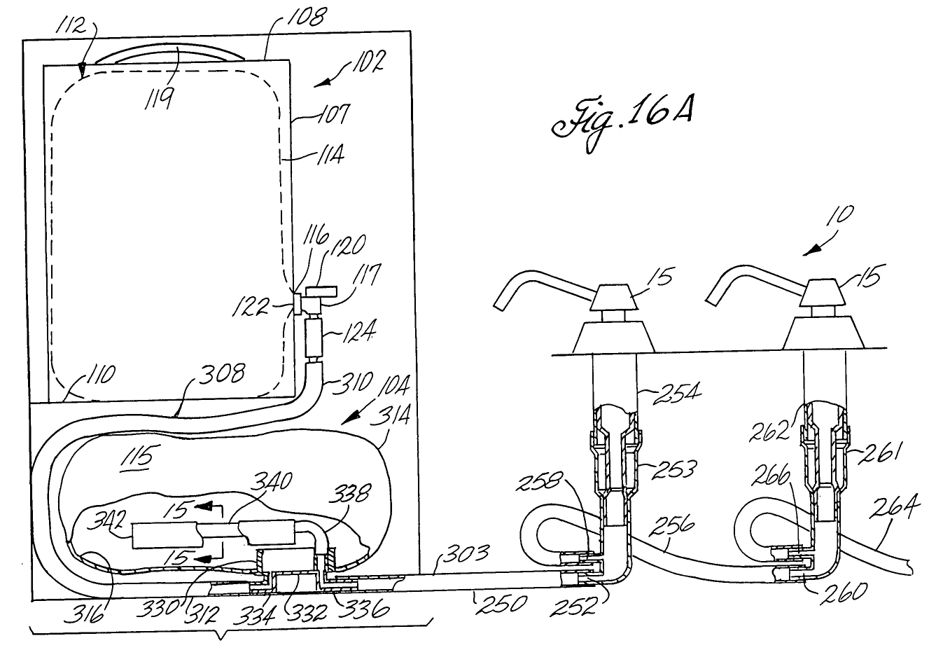

The second collapsible container 115 includes a wall 314, an interior surface 316, a port 330, a lid 332, an inlet connection tube 334, an outlet connection tube 336, a J-shaped tube 338, a withdrawal tube 340, and a tube support 342. The port is positioned through the wall of the second collapsible container. The lid connects to the port forming an airtight seal between the lid and the port. The lid includes the inlet connection tube and outlet connection tube. One end of the J-shaped tube is coupled, in fluid communication, to an end of the outlet connection tube, while the other end of the J-shaped tube is coupled, in fluid communication, to the withdrawal tube. The tube support is H-shaped in cross section and connected to the withdrawal tube, along its length, as shown in FIGS. 14 and 15. The tube support helps to hold the withdrawal tube in a horizontal position and to provide a spacer between the interior surface of the second collapsible container and the withdrawal tube.

The first connecting line 308 includes a first end 310 and a second end 312. The first end is coupled, in fluid communication, to the first collapsible container 114, and the second end is coupled, in fluid communication, to the inlet connection tube 334 of the second collapsible container 115. In addition, the second connecting line 303 couples, in fluid communication, one end of the outlet connection tube 336 to the liquid dispensers 15.

In the embodiment of the present invention shown in FIGS. 14 and 15, liquid flows from the first collapsible container 114 through the first connecting line 308 and inlet connection tube 334, into the second collapsible container 115. Liquid leaves the second collapsible container after passing through the withdrawal tube 340, the J-shaped tube 338, and the outlet connection tube 336. In this configuration, liquid entering the second collapsible container must fill the second collapsible container to the elevation of the withdrawal tube before it is allowed to exit the second collapsible container. This feature is advantageous in that it forces liquid to fill at least a portion of the second collapsible container and not just flow directly from the inlet connection tube to the outlet connection tube.

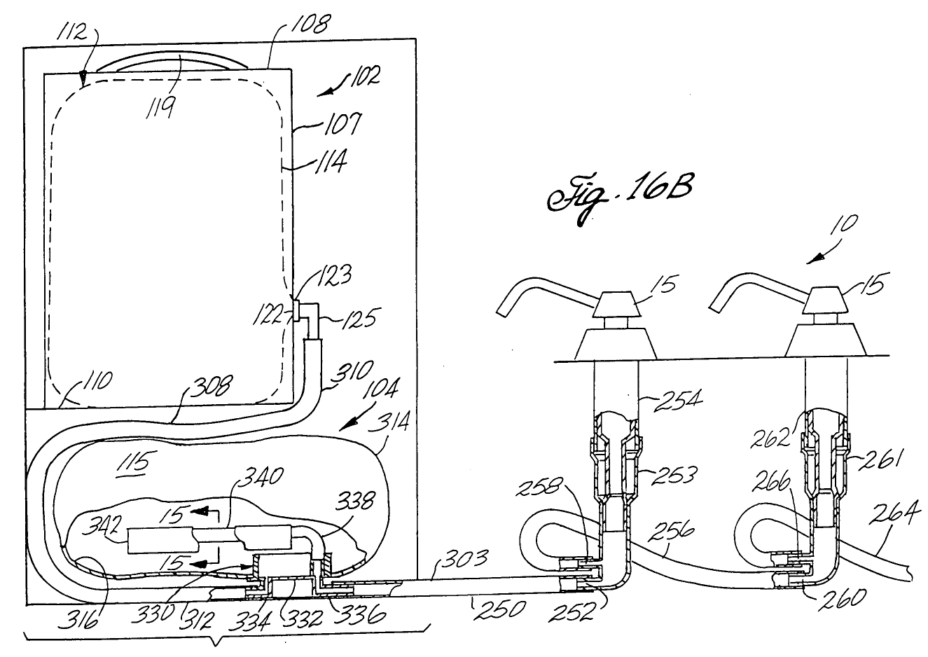

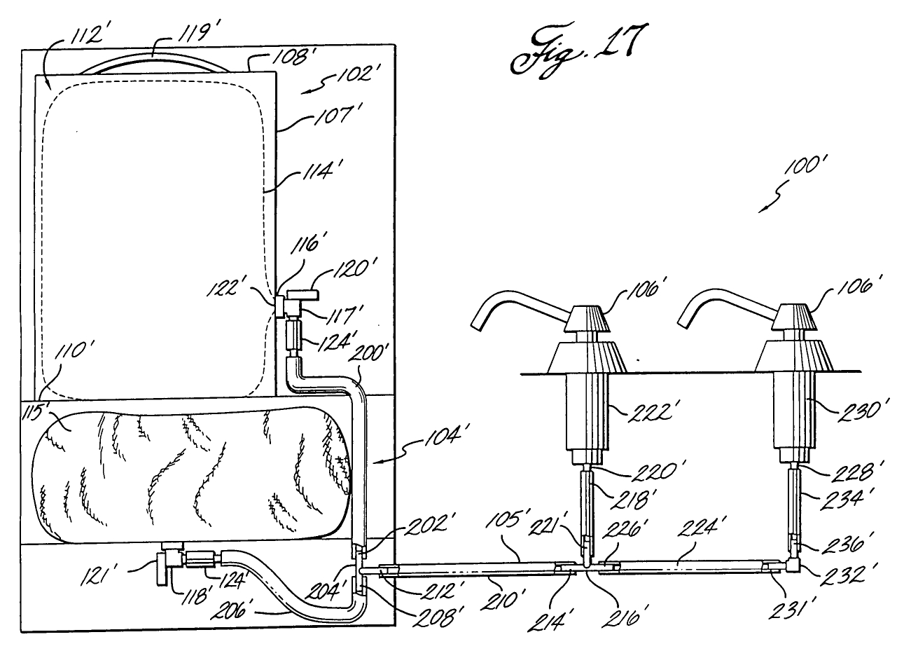

FIG. 16A is a depiction of another embodiment of the invention shown in FIG. 14. Where appropriate the same reference numerals are used to avoid unnecessary duplication and description of similar elements already referred to and described above. Only significant differences of the embodiment will be discussed hereafter. In FIG. 16A, the second connecting line 303 has a modified configuration similar to that of the embodiment of the invention in FIG. 13A. FIG. 16A shows a first dispenser adapter 253 connected to the base of a first liquid dispenser 254. Similarly, a second dispenser adapter 261 is connected to the base of a second liquid dispenser 262. With reference to FIG. 16A, a first tube 250 is coupled between the outlet connection tube 336 and an inlet 252 of the first dispenser adapter. A second tube 256 is coupled between an outlet 258 of the first dispenser adapter and an inlet 260 of the second dispenser adapter. A third tube 264 may be coupled between an outlet 266 of the second dispenser adapter and an inlet (not shown) of a third dispenser adapter (not shown). If a third tube is not utilized, the outlet of the second dispenser adapter may be sealed with a cap (not shown). The flow of liquid into the first and second liquid dispensers is similar to that discussed for the embodiment in FIG. 13A.

FIG. 16B is a depiction of another embodiment of the invention shown in FIG. 16A. Where appropriate the same reference numerals are used to avoid unnecessary duplication and description of similar elements already referred to and described above. Only significant differences of the embodiment will be discussed hereafter. In FIG. 16B, the first collapsible container 114 is disposed within the carton 107. A first container nozzle 123 is carried on the carton and is coupled to the outlet 122 of the first collapsible container. One end of a first container mating cap 125 threadably engages the first container nozzle, and the opposing end of the first container mating cap is connected to the first end 310 of the first connecting line 308. While any nozzle and mating cap may be utilized, the presently preferred nozzle and mating cap for the first container nozzle and first container mating cap are those of connection 21 in FIG. 1. The flow of liquid through the first container nozzle and first container mating cap is the same as that of the embodiment of FIG. 13B.

Advantages of the liquid feed system 10 of the present invention include the following. The liquid feed system delivers liquid, such as, soap or lotion, through liquid dispensers 15 which can be mounted directly to the wall 20 or a counter 13, without costly stainless steel soap vessels attached to them. Since the liquid feed system has no expensive vessels with which to tamper, the liquid feed system is inexpensive and essentially vandal proof. Also, the liquid feed system can handle a wide range of soap viscosity from water thin to shampoo-like thicknesses. In addition, the liquid feed system is hygienic and poses no threat of contamination. Moreover, this low-cost installation and maintenance liquid feed system is especially suitable for use in fast food restaurants and other facilities with high public traffic where frequent interruptions for servicing the liquid feed system is undesirable.

Another advantage of the liquid feed system 10 is that it has a centrally-located collapsible fluid container 16, or first and second collapsible containers 114, 115, for supplying all of the liquid dispensers 15. A single refill or replacement of the centrally-located fluid container(s) will supply the complete washing room 11. Also, the centrally-located fluid container(s) can be mounted on the floor level, under the counter, or in a remote area. In addition, the line 18 or connecting tubes 200, 206, 210, 218, 224, 234, 250, 256, 264, 301, 308 of the liquid feed system are non-collapsible and will remain filled with liquid at all times for quick priming since the liquid dispensers will stop delivery of liquid once the centrally-located container(s) are empty.

Another embodiment of the liquid feed system is shown in FIG. 17 wherein the washing system has parallel reservoirs. In this configuration the first reservoir is positioned above the second reservoir and the fitting is preferably positioned below the second reservoir. An advantage of positioning the fitting below the second reservoir is that air present in the first reservoir will not be drawn into the fitting when the first reservoir is empty and dispensing liquid is being drawn from the second reservoir. This eliminates the need to reprime the system in order to draw dispensing liquid from the second reservoir, after the first reservoir is emptied.

In an alternative embodiment, a small diameter tubing connects the second reservoir to the fitting. The small diameter tubing has a smaller internal diameter than the tubing connecting the first reservoir to the fitting. An advantage of this feature is that the dispensing fluid is drawn more easily from the first reservoir thereby preventing the lower reservoir from diminishing until after the first reservoir is completely empty.

FIG. 17 illustrates an alternative embodiment of the configuration shown in FIG. 7. In this embodiment, the outlet nozzle 118′ is located on the bottom of the collapsible soap container 115′ of the secondary reservoir 104′. As with the configuration shown in FIG. 7, connecting tube 206′ is coupled between the adapter 124′ on the outlet nozzle 118′ of the collapsible soap container 115′ of the secondary reservoir 104′ and a second inlet 208′ of the first T-connector 204′. However, as shown in FIG. 17, the first T-connector 204′ is positioned so that it is below the bottom of the secondary reservoir 104′. The first connecting tube 200′ is extended to couple with the first inlet 202′ of the first T-connector 204′. With the first T-connector 204′ below the secondary reservoir 104′, dispensing liquid will remain in the first connecting tube 200′ after the first reservoir 102′ is empty and the dispensing fluid is being drawn from the secondary reservoir 104′. Fluid remains in the first connecting tube 200′ due to the head pressure of the dispensing liquid in the secondary reservoir 104′. This configuration prevents any air that may be present in the collapsible soap container 114′ of the first reservoir 102′ from entering the connecting line 105′ and necessitating that the washing system 100′ be reprimed.

It is to be appreciated that the outlet nozzle 118′ need not be located on the bottom of the collapsible soap container 115′ of the secondary reservoir 104′, in order to configure the washing system so that the first T-connector 204′ is positioned below the secondary reservoir.

In an alternative embodiment of the configuration shown in FIGS. 7 and 17, the second connecting tube 206′ has a smaller inner diameter than the first connecting tube 200′. The smaller diameter of the second connecting tube 206′, known as a restrictive tube, reduces the volume of dispensing fluid that can be drawn through the tube and also increases the forces necessary to draw fluid through the secondary tube relative to the larger first connecting tube 200′ because of increased viscous forces. Restricting the flow of dispensing fluid from the secondary reservoir 104, further ensures that the secondary reservoir does not diminish until the first reservoir 102 is empty which is one of the advantages of the two reservoir configuration.

Those skilled in the art will recognize that other modifications and variations can be made in the liquid feed system 10 of the present invention and in construction and operation of this liquid feed system without departing from the scope or spirit of this invention.

1. A soap or lotion dispensing system, comprising:
at least one fluid container containing soap or lotion, the container having an outlet;
a first soap or lotion dispenser having a base and an adapter extending down from the base, the adapter having an outlet to feed soap or lotion from the at least one fluid container into the base, a first port and a second port; and
at least one delivery tube, the at least one delivery tube coupling, in fluid communication, the outlet of the at least one fluid container to the first port of the adapter.

2. The soap or lotion dispensing system of claim 1 further comprising a second soap or lotion dispenser and an outlet tube, wherein the outlet tube extends in fluid communication, from the second port of the adapter to an inlet of the second soap or lotion dispenser.

3. The soap or lotion dispensing system of claim 2, wherein the first soap or lotion dispenser includes a manually operable positive displacement pump.

4. The soap or lotion dispensing system of claim 3, wherein the first port and the second port open transversely to a pumping axis of the pump.

5. The soap or lotion dispensing system of claim 4, wherein one port is located above the other port.

6. The soap or lotion dispensing system of claim 5, wherein the adapter is a continuous one-piece part.

7. The soap or lotion dispensing system of claim 2, wherein the delivery tube and the outlet tube are flexible tubes.

8. The soap or lotion dispensing system of claim 2, wherein the delivery tube includes a first tube and a second tube and further comprising a connecting link adapter having a first portion and a second portion matable to the first portion, wherein the first portion is coupled, in fluid communication, to the first tube, and the second portion is coupled, in fluid communication, to the second tube;
wherein the first portion includes a valve actuated by connecting and disconnecting the first portion to the second portion, so that the liquid flows from the container to the second tube when the first portion is connected to the second portion, and liquid is prevented from flowing from the container, via the first portion, when the first portion is disconnected from the second portion; and
wherein the second portion includes a valve that is actuated by connecting and disconnecting the first portion to the second portion, whereby liquid is permitted to flow from the container to the second tube when the first portion is connected to the second portion, and liquid is prevented from flowing out of the second tube, via the second portion, when the first portion is disconnected from the second portion.

9. The soap or lotion dispensing system of claim 2, further comprising a conduit strip having opposing ends, a plurality of conduit ridges, and a plurality of conduit channels, the conduit strip connected to the interior surface of the container, one end of the conduit strip adjacent the outlet and the other end of the conduit strip spaced further away from the outlet than the one end.

10. The soap or lotion dispensing system of claim 1, wherein the at least one fluid container containing soap or lotion includes
a first collapsible container containing soap or lotion;
a second collapsible container containing soap or lotion, the second collapsible container located at an elevation lower than the elevation of the first collapsible container; and
the at least one delivery tube coupling, in fluid communication, the first collapsible container to the second collapsible container and the first and second collapsible containers to the first soap or lotion dispenser.

11. The soap or lotion dispensing system of claim 10 further comprising a second soap or lotion dispenser and an outlet tube, wherein the outlet tube extends in fluid communication, from the second port of the adapter to an inlet of the second soap or lotion dispenser.

12. The soap or lotion dispensing system of claim 11, wherein the first soap or lotion dispenser and the second soap or lotion dispenser each include a manually operable positive displacement pump.

13. The soap or lotion dispensing system of claim 12, wherein each port opens transversely to a pumping axis of the pump.

14. The soap or lotion dispensing system of claim 13, wherein one port is located above the other port.

15. The soap or lotion dispensing system of claim 14, wherein the adapter is a continuous one-piece part.

16. The soap or lotion dispensing system of claim 11, wherein the delivery tube and the outlet tube are flexible tubes.

17. The soap or lotion dispensing system of claim 10, wherein the delivery tube includes a shutoff tee having a first portion and a second portion matable to the first portion, wherein the first portion is coupled, in fluid communication, to one of the first and second collapsible containers, and the second portion is coupled, in fluid communication, to the first soap or lotion dispenser;
wherein the first portion includes a valve actuated by connecting and disconnecting the first portion to the second portion, so that the liquid flows from the one of the first and second collapsible containers to the first dispenser when the first portion is connected to the second portion, and liquid is prevented from flowing from the one of the first and second collapsible containers, via the first portion, when the first portion is disconnected from the second portion; and
wherein the second portion includes a valve that is actuated by connecting and disconnecting the first portion to the second portion, whereby liquid is permitted to flow from the one of the first and second collapsible containers to the first dispenser when the first portion is connected to the second portion, and liquid is prevented from flowing out of the first dispenser, via the second portion, when the first portion is disconnected from the second portion.

18. The soap or lotion dispensing system of claim 11, further comprising a conduit strip having opposing ends, a plurality of conduit ridges, and a plurality of conduit channels, the conduit strip connected to the interior surface of one of the first and second collapsible containers, one end of the conduit strip adjacent an outlet of the one of the first and second collapsible containers and the other end of the conduit strip spaced further away from the outlet than the one end.

19. The soap or lotion dispensing system of claim 10 wherein the second collapsible container defines an outlet and has a nozzle extending from the outlet.

20. The soap or lotion dispensing system of claim 19 wherein the outlet of the second collapsible container opens downwardly through a bottom wall of the second collapsible container.

21. The soap or lotion dispensing system of claim 19 wherein the outlet of the second collapsible container is located closer to a bottom wall of the second collapsible container than to a top wall of the second collapsible container when the second collapsible container is full of soap or lotion.
